(19) United States
(12) Patent Application Publication
(10) Pub. No.: US 2007/0212464 A1
(43) Pub. Date: Sep. 13, 2007

(54) Device And Method For Rolling Cold Cuts

(76) Inventor: Wilfried Maier, Dietmannsried (DE)

Correspondence Address: PERMAN & GREEN, 425 POST ROAD, FAIRFIELD, CT, 06824, US

(21) Appl. No.: 10/582,432

(22) PCT Filed: Dec. 10, 2004
(86) PCT No.: PCT/EP04/14101

§ 371 Date: Mar. 27, 2007

(30) Foreign Application Priority Data
Dec. 10, 2003 (DE) 103 58 069.7

(51) Int. Cl. A23P 1/10; A23G 3/02; A23P 1/00

(52) U.S. Cl. 426/517; 99/485

(57) ABSTRACT

The invention relates to a device for rolling sliced food including a first end and a second end. The device encompasses an optional means for bending the first end of the sliced food item, at least one means for conveying the sliced food item, and a means which is located above the conveying means, bends the sliced food item as required, and rolls up the bent sliced food item. The invention further relates to a method for rolling sliced food.

The present invention relates to a device and a method for rolling food product slices.

These days, food product slices are offered for sale in the most varied forms. For example there is commercial demand for food product slices, in particular ham slices, which are laid out in a fluted or shingled arrangement In future, it is intended also to offer the consumer rolled food product slices.

It was therefore an object of the present invention to provide a device and a method for rolling food product slices.

The object is achieved according to the invention with a device for rolling food product slices which comprise a first end and a second end, optionally having a bending means with which the first end of the food product slice may be bent, at least one conveying means with which the food product slice may be transported, and a means, located above the conveying means, which optionally bends the food product slice and rolls up the bent food product slice.

It was extremely surprising to the person skilled in the art and not at all expected that it should be possible, with these very simple means, to roll food product slices of virtually any desired consistency and shape. Rolling up of the food product slices may be interrupted at any time and then continued. A plurality of food product slices may be rolled up in parallel.

For the purposes of the invention, a food product slice is for example a slice of sausage, ham or cheese.

Optionally, the device comprises a bending means, with which the first end of the food product slice may be bent. For the purposes of the invention bent means that the food product slice is no longer completely flat, but rather has been bent upwards preferably in the area of the first end. Any means familiar to the person skilled in the art is possible as bending means. However, this means is preferably a freely rotating or driven roller, which is particularly preferably height-adjustable. If the device according to the invention does not comprise a bending means, the food product slice is bent by the means for rolling up the food product slice.

In a preferred embodiment of the present invention, the bending means is arranged in the trajectory of a severed food product slice between a slicer and a portioning belt and/or conveying means. As the food product slice which has just been severed falls for example onto the conveying means, its first end comes into contact with the bending means, preferably rotatably mounted rollers, such that the speed of the first end of the food product slice is reduced in comparison to the speed of the second end of the food product slice and the food product slice is thereby bent.

In another preferred embodiment of the present invention, the bending means is for example once again a roller, which is arranged beneath the means with which the food product slice is rolled up. With the bending means, the first end of the food product slice is raised and then rolled up by the rolling means.

The bending means and the means with which the food product slice is rolled up may be two different components. However, it is also possible for the two functions to be combined in one component, for example a stationary or driven belt, a plate or a flat, flexible material.

The means with which the food product slice is bent and/or the bent food product slice is rolled up preferably consists of a flat flexible material. Particularly preferably, the means is a textile, in particular a cloth, or a film/foil. The size of the roll may be influenced by the size and weight of the flexible material, preferably of the cloth. The longer and heavier is the flat, flexible material, in particular cloth, the more tightly the food product roll is rolled up and the smaller is the food product roll produced.

In another preferred embodiment, the bending and/or rolling means is a belt, which may optionally be drivable and optionally be of height-adjustable construction.

In a further preferred embodiment, the bending means is likewise height-adjustable and/or particularly preferably drivable.

The present invention further provides a method of rolling food product slices, in which the food product slices are partially bent and then rolled between a conveying means and a rolling means.

It was extremely surprising to the person skilled in the art and not at all expected that it should be possible, with such a simple method, to produce rolled food product slices of any desired size. Rolling up of the food product slices may be interrupted at any time and then continued. A plurality of food product slices may be rolled up in parallel.

Preferably, the finished food product rolls are rolled into packaging.

In addition, the food product rolls are preferably packaged individually or in groups. It is also feasible, however, for a plurality of individually packaged food product rolls to be combined in one package.

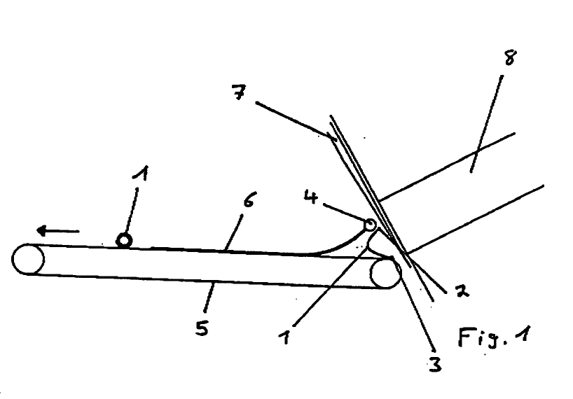

The invention is explained below with reference to FIGS. 1 to 5. These explanations are given merely by way of example and do not restrict the general concept of the invention. The explanations apply both to the device according to the invention and to the method according to the invention.

FIG. 1 shows an embodiment of the present device, in which the bending means is arranged in the trajectory of the food product slice.

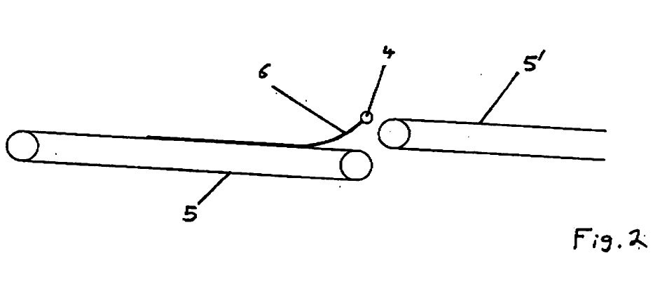

FIG. 2 shows an embodiment of the device according to the invention with two conveyor belts, a bending means and a cloth for rolling up the slices.

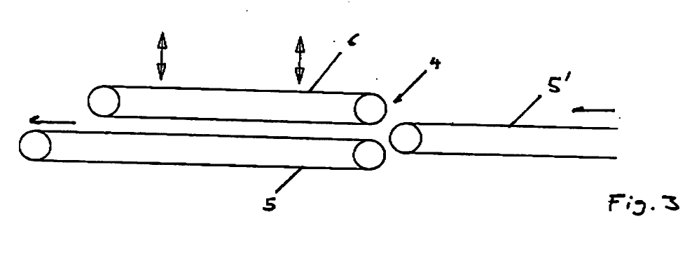

FIG. 3 shows an embodiment of the device according to the invention with two conveyor belts and a stationary belt.

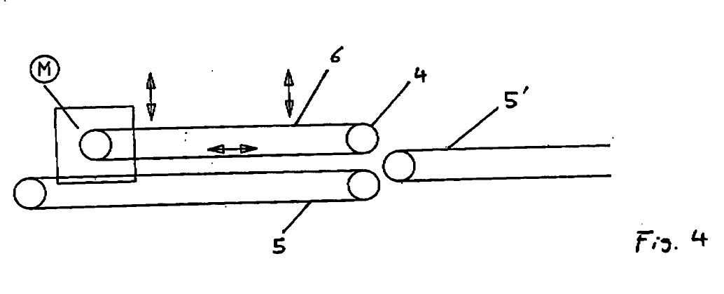

FIG. 4 shows the device according to FIG. 3, wherein all three belts are driven.

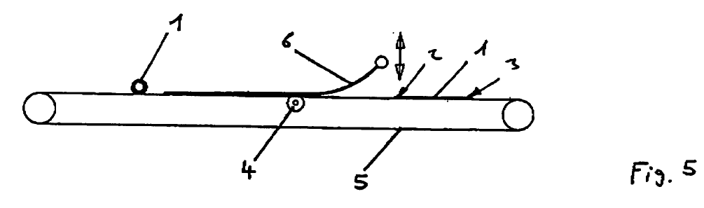

FIG. 5 shows an embodiment of the device according to the invention with a bending means beneath the means for rolling up the food product slices.

FIG. 1 shows the device according to the invention for rolling up food product slices. Food product slices 1 are severed from a food product block 8, which consists for example of sausage, cheese or ham, with a slicer, of which only the blade 7 is illustrated, and fall onto the conveyor belt 5. In the trajectory of the food product slices 1 there is arranged a bending means 4, in the present case freely rotatable rollers which extend into the plane of the paper, on which the first end 2 of the food product slice 1 impinges, slowing this end down in comparison to the rest of the food product slice, such that it bends, as shown in FIG. 1. The slice bent in this way is transported leftwards by the conveyor belt 5, as shown by the arrow, such that the first, bent end 2 of the food product slice 1 comes into contact with the cloth 6. As a result of the friction between the cloth 6 and the food product slice and as a result of transportation of the food product slice 1 by means of the conveyor belt 5, the food product slice is rolled up. The length by which the cloth 6 extends in the conveying direction of the food product slice and/or the weight of the cloth may be used to influence the shape of the roll. The heavier and longer is the cloth, the more tightly the food product slice is rolled up. A comparatively long and heavy cloth also has the effect that the food product slice 1 unrolls again, as soon as it is no longer in engagement with the cloth 6. The rolled-up slice 1 is transported on for example to a packaging machine, where it is rolled into preproduced packaging. The food product slices may be packaged individually or in groups.

FIG. 2 shows another embodiment of the device according to the invention. In this case, a food product slice (not shown) is transported by a conveyor belt 5′ in the direction of the bending means 4. As soon as the food product slice comes into contact with the bending means 4, in this case likewise freely rotatable rollers, the first end of the food product slice is raised and, as the food product slice is transported further and falls onto the conveyor belt 5, the bent part of the food product slice comes into engagement with the cloth 6 and the food product slice is rolled while being transported leftwards by the conveyor belt 5. The person skilled in the art will recognise that it is advantageous for the bending means 4 to be height-adjustable. The person skilled in the art will also recognise that in the present case it is also possible to dispense with the bending means. In this case, the food product slice impinges directly against the cloth, is bent thereby and rolled up in interplay with the conveyor belt 5. Preferably, the right-hand end of the cloth 6 is height-adjustable. As far as the length and weight of the cloth are concerned, reference is made to the statements made in relation to FIG. 1.

FIG. 3 shows a further embodiment of the device according to the invention, in which the bending means and the means for rolling the slices are combined into one component, a conveyor belt. The food product slice (not shown) is transported with the conveyor belt 5′ in the direction shown by the right-hand arrow and impinges with its first end against the right-hand roller of the belt 6, which in this case is not driven, and is bent upwards in the process. The slice bent in this way falls onto the conveyor belt 5, which conveys it on in the direction shown by the left-hand arrow. Because the bent part of the food product slice comes into engagement with the belt 6, the food product slice is rolled up by the driven conveyor belt 5 as it is conveyed along. The double-headed arrow is intended to indicate that the belt 6 is height-adjustable. The smaller the gap between the belt 6 and the conveyor belt 5, the tighter the food product roll. The person skilled in the art will recognise that the belt 6 may also take the form of a plate. The person skilled in the art will also recognise that it may be advantageous for the conveyor belt to be inclined such that the gap between the belt or the plate 6 and the conveyor belt 5 tapers in the conveying direction.

FIG. 4 essentially shows the embodiment of the device according to the invention in accordance with FIG. 3, wherein in this case the belt 6 is also driven by a motor, designated M. As shown by the horizontal double-headed arrow, the conveyor belt may revolve in both directions, wherein it is advantageous for rolling up of the food product slices, however, for the directions in which the belts revolve to differ or for the speed of the belt 6 to be lower than the speed of the conveyor belt 5.

FIG. 5 shows a further embodiment of the device according to the invention. The food product slice 1 is transported by the conveyor belt 5 preferably continuously in the direction shown by the arrow and runs into an advantageously textured roller, which may optionally be driven. The first end 2 of the food product slice 1 is raised by the roller 4 and the underside thereof is brought into engagement with a cloth 6 and rolled up thereby during further conveying by the conveyor belt 5. The rolled-up slice is transported on for example to a packaging machine. The double-headed arrow is intended to symbolise the fact that the right-hand end of the cloth is preferably height-adjustable.

The statements made in relation to all the Figures apply equally to the device and to the method.

In all the embodiments described, rolling up of the food product slices may be interrupted at any time and then continued. A plurality of food product slices may be rolled up in parallel.

### REFERENCE NUMERALS

1 Food product slice

2 First end of food product slice

3 Second end of food product slice

4 Bending means

5, 5′ Conveying means

6 Means for rolling the bent food product slice

7 Slicer

8 Food product block

1. A device for rolling food product slices (1) which comprise a first end (2) and a second end (3), having
optionally a bending means (4), with which the first end (2) of the food product slice (1) may be bent,
at least one conveying means (5,5′), with which the food product slice (1) may be transported and
a means (6), located above the conveying means (5), which optionally bends the food product slice and rolls up the bent food product slice (1).

2. A device according to claim 1, characterised in that the bending means (4) is a roller, which is preferably height-adjustable.

3. A device according to claim 1, characterised in that the bending means (4) is arranged between a slicer (7) and the conveying means (5) in the trajectory of a severed food product slice (1).

4. A device according to claim 1, characterised in that the bending means is arranged beneath the means (6).

5. A device according to claim 1, characterised in that the bending means (4) and the means (6) are of one-piece construction.

6. A device according to claim 1, characterised in that the means (6) consists of a flat and flexible material and is preferably a cloth.

7. A device according to claim 5, characterised in that the length and/or weight of the flexible material influences the size of the roll.

8. A device according to claim 1, characterised in that the means (6) is a belt.

9. A device according to claim 1, characterised in that the bending means (4) is height-adjustable and/or drivable.

10. A method for rolling food product slices, characterised in that the food product slices are partially bent and then rolled between a conveying means (5) and a means (6).

11. A method according to claim 10, characterised in that the finished food product rolls are rolled into packaging.

12. A method according to claim 11, characterised in that the rolls are packaged individually and/or in groups.
